(19) United States
(12) Patent Application Publication
(10) Pub. No.: US 2013/0040826 A1
(43) Pub. Date: Feb. 14, 2013

(54) METHODS FOR TRAIT MAPPING IN PLANTS

(71) Applicants: Carl J. Braun, III, Woodland, CA (US); David Caldwell, St Louis, MO (US); Joel Kniskern, Sacramento, CA (US); Ryan Rapp, Addieville, IL (US)

(72) Inventors: Carl J. Braun, III, Woodland, CA (US); David Caldwell, St Louis, MO (US); Joel Kniskern, Sacramento, CA (US); Ryan Rapp, Addieville, IL (US)

(21) Appl. No.: 13/574,070

(22) PCT Filed: Jan. 19, 2011
(86) PCT No.: PCT/US11/21654

§ 371 Date: Oct. 15, 2012

Related U.S. Application Data
(60) Provisional application No. 61/296,253, filed on Jan. 19, 2010.
(60) Provisional application No. 61/378,644, filed on Aug. 31, 2010.

(51) Int. Cl. C40B 20/00

(52) U.S. Cl. 506/2

(57) ABSTRACT

The present invention provides methods for identifying the nucleic acid sequences responsible for phenotypic traits in plants.

### CROSS REFERENCE TO RELATED APPLICATIONS

This application claims priority from U.S. Provisional Application Ser. No. 61/296,253 filed (Jan. 19, 2010) and U.S. Provisional Application Ser. No. 61/378,644 filed (Aug. 31, 2010), both of which are incorporated by reference herein in their entirety.

### FIELD OF INVENTION

This invention is in the field of plant breeding. More specifically, this invention relates to the use of high throughput sequencing and marker discovery technologies for identifying polymorphisms and genes responsible for phenotypic traits in plants.

### BACKGROUND OF INVENTION

The primary objectives of plant breeding are to select an optimal pair of parents to make a cross and then to select one or more superior progeny resulting from that cross. In hybrid crops, a third objective is to identify a tester to make up high performing hybrid seed. Traditional plant breeding has relied on visual observations and performance data on the plants or lines in order to make selections to meet one of the aforementioned objectives.

In recent years, molecular breeding has demonstrated promise for improving the breeding process and enhancing the rate of genetic gain. In molecular breeding, molecular markers provide a basis for parental, progeny or tester selections; this process may be used in conjunction with phenotype-based selection as well. Inclusion of genetic markers in breeding programs has accelerated the identification and accumulation of valuable traits into germplasm pools compared to that achieved based only on phenotypic data. Herein, “germplasm” includes breeding germplasm, breeding populations, collection of elite inbred lines, populations of random mating individuals, and biparental crosses.

For molecular breeding to be effective, the differences in marker genotypes must be heritably associated to one or more phenotypic or performance traits. These associations are established by correlating the marker genotypes to lines or populations segregating for one or more traits. Genetic marker alleles (an “allele” is an alternative sequence at a locus) are used to identify plants that contain a desired genotype at one or more loci, and that are expected to transfer the desired genotype, along with a desired phenotype for one or more traits, to their progeny. Markers that are highly correlated with a phenotype are assumed to be genetically linked to the trait, thus the marker can then be used as a basis for selection decisions in lieu of evaluating the trait per se. Markers that are not correlated will be inherited independently of the trait and are not useful for selections, but can be valuable in comparing similarities and/or measuring genetic distances among varieties and lines. Ideally, the marker will represent the actual genomic variation responsible for a trait and will therefore always segregate with the trait, although the correlations can be masked by phenomena such as environmental interactions or epistatic effects.

Initial marker platforms for molecular breeding did not require a priori knowledge of underlying sequence. These markers were based on restriction fragment length polymorphisms (RFLPs). Random or directed DNA probes were used in Southern hybridization protocols to identify target fragments whose size varied depending on the location and distance between a pair of restriction enzyme recognition sites. These differences in size could be correlated to traits in test populations. The DNA probes were then used as markers that could detect the underlying restriction fragment length polymorphisms and in turn be used to predict a correlated trait. Other types of markers have been used that require a priori knowledge of the underlying sequence and include but are not limited to fingerprinting using amplified fragment length polymorphisms (AFLPs) or universal PCR primers (i.e. RICE primers).

In recent years, markers have been developed based on the knowledge of an underlying sequence. For example, microsatellite or simple sequence repeat (SSR) markers rely on PCR and gel electrophoresis to elucidate variation in the length of DNA repeat sequences. The differences in repeat length, as revealed by the markers, can correlate to associated traits if the target repeat is genetically linked to the trait.

Other types of variations useful as traditional markers are single nucleotide polymorphisms (SNPs). These are single base changes which differ between two lines and will segregate with a trait in which they are genetically linked. SNPs can be detected by a variety of commercially available marker technologies. Markers based on SNPs have gained in popularity due to the ease and accuracy of detection, compatibility with information systems and low cost. However, SNP markers are still an indirect tool for querying underlying sequence and a SNP marker is restricted to only detecting two alleles, not the four possible nucleotides that might be found at any given nucleotide position.

Bulk segregant analysis (BSA) is a method developed for the rapid identification of linkage between markers and traits of interest (Michelmore et at., 1991 Proc. Natl. Acad. Sci. (U.S.A.) (88:9828-9832). In BSA, two bulked DNA samples are drawn from a segregating population originating from a single cross. These bulks contain individuals that are identical for a particular trait (resistant or susceptible to particular disease) or genomic region but arbitrary at unlinked regions (i.e. heterozygous). Regions unlinked to the target region will not differ between the bulked samples of many individuals in BSA.

However, these traditional marker discovery platforms are suboptimal because they are not suited for automation or high throughput sequencing techniques. In addition, traditional marker discovery platforms are susceptible to false marker-trait associations wherein the identity of a genotype between two lines may not reflect a common parent but a convergent sequence, which is problematic for tracking specific marker alleles across multiple generations.

Thus, there is a need in the art for methods to quickly and accurately determine direct sequence information from at least one plant genome responsible for at least one phenotypic trait of interest which are segregating in a cross between two plants in an unstructured plant population for the purpose of facilitating plant breeding activities such as line development, germplasm diversity analyses, rare allele mining, purity testing, quality assurance, introgression of specific genomic regions, stacking of genomic regions, prediction of line performance, and prediction of hybrid performance.

### SUMMARY OF THE INVENTION

This invention describes novel methods that utilize high throughput sequencing and molecular breeding methodologies to enable the use of direct sequencing information in molecular plant breeding. The methods allows for quick and accurate deduction of nucleic acid sequence information from at least one plant for at least one phenotypic trait of interest that are segregating in a cross between two plants or in an unstructured population. Individuals that are differentially scored for the phenotype of interest are pooled, DNA is extracted and a characterized portion of the genome is captured using sequence capture technology or reduced representation libraries. High throughput sequencing is performed and the subsequent reads are mapped back to a reference genome. A statistical model is used to isolate regions responsible for the phenotypic traits with a certain accuracy based on the frequency of SNPs between the pools examined. Map information and diagnostic SNPs can then be used to quickly introgress, exchange or monitor regions of DNA responsible for phenotypic traits. Examples of uses would be identification of genes responsible for resistance to pathogens, identification of DNA linked to higher yield, and identification DNA responsible for agronomic traits.

In one embodiment, the invention is directed to a method of plant breeding. The method comprises establishing a fingerprint map defining a plurality of loci within the genome of a breeding population of plants; associating a QTL allele with known map location with a phenotypic trait in a mapping population; and assaying for presence of the QTL allele and at least one nucleic acid sequence within the plurality of loci to predict expression of the phenotypic trait in a population other than the mapping population.

In another embodiment, the invention is directed to a method of marker assisted breeding. The method comprises providing a breeding population comprising at least two plants and associating at least one phenotypic trait with a locus of the genome of the plants, provided that the locus is defined by at least one nucleic acid sequence. The population is then assayed for the presence of at least one nucleic acid sequence of the locus to predict the expression of at least one phenotypic trait in a progeny plant of the breeding population.

In a further embodiment, the invention is directed to a method for identifying polymorphisms in a population of plants. The method comprises screening a population of plants for at least one phenotype of interest, and separating plants from the population into at least two subpopulations of plants that are segregating for the at least one phenotype of interest. DNA from one or more plants in each of the subpopulations of plants is isolated and pooled, and each set of pooled DNA is sequenced to determine the sequence of a plurality of nucleic acids for the genome of each pool from each of the subpopulations of plants. Finally, one or more polymorphisms linked to one or more genes controlling the selected phenotype of interest is identified in the genome of each pool. In certain embodiments, the method to identify the phenotype of interest is controlled by a monogenic, polygeneic or oligogenic trait.

In a further embodiment, the invention is directed to a method for identifying polymorphisms in a population of plants. The method comprises screening a population of plants for at least one phenotypic trait and selecting at least one plant from the population of plants that screened as positive for the at least one phenotypic trait. DNA from the at least one plant screening positive is isolated and collected to create a positive DNA pool. Similarly, at least one plant from the population screening as negative for the at least one phenotypic trait is selected from the population, and DNA is isolated and collected from the at least one negative plant to create a negative DNA pool. Each of the positive DNA pool and the negative DNA pool is sequenced to determine the sequence of a plurality of nucleic acids for the genome of each of said positive DNA pool and said negative DNA pool. Finally, one or more polymorphisms linked to one or more genes controlling the at least one phenotypic trait is identified from the sequence information for the positive DNA pool or the negative DNA pool.

The methods of the invention provide plant breeders with better tools for parent selection, progeny selection, choosing tester combinations, developing pedigrees, fingerprinting samples, screening for haplotype diversity, ensuring quality, assessing germplasm diversity, measure breeding progress, providing variety or line descriptions and for building databases of sequence associations to trait and performance data. Such databases provide the basis for calculating nucleic acid effect estimates for one or more traits, wherein associations can be made de novo or by leveraging historical nucleic acid sequence-trait association data.

In the present invention, a breeding selection may be conducted directly on a sequence, rather than indirectly on a marker, basis, wherein a first plant is crossed with a second plant that contains at least one sequence that is different from the first plant sequence or sequences; and at least one progeny plant is selected by detecting the sequence or set of sequences of the first plant, wherein the progeny plant comprises in its genome one or more sequences of interest of the first plant and at least one sequence of interest of the second plant; and the progeny plant is used in activities related to germplasm improvement, herein defined as including using the plant for line and variety development, hybrid development, transgenic event selection, making breeding crosses, testing and advancing a plant through self fertilization, purification of lines or sublines, using plant or parts thereof for transformation, using plants or parts thereof for candidates for expression constructs, and using plant or parts thereof for mutagenesis.

The present invention includes a method for breeding of a plant, such as maize (Zea mays), soybean (Glycine max), cotton (Gossypium hirsutum), peanut (Arachis hypogaea), barley (Hordeum vulgare); oats (Avena sativa); orchard grass (Dactylis glomerata); rice (Oryza sativa, including indica and japonica varieties); sorghum (Sorghum bicolor); sugar cane (Saccharum sp); tall fescue (Festuca arundinacea); turfgrass species (e.g. species: Agrostis stolonifera, Poa pratensis, Stenotaphrum secundatum); wheat (Triticum aestivum), and alfalfa (Medicago sativa), members of the genus Brassica, broccoli, cabbage, carrot, cauliflower, Chinese cabbage, cucumber, dry bean, eggplant, fennel, garden beans, gourd, leek, lettuce, melon, okra, onion, pea, pepper, pumpkin, radish, spinach, squash, sweet corn, tomato, watermelon, ornamental plants, and other fruit, vegetable, tuber, oilseed, and root crops, wherein oilseed crops include soybean, canola, oil seed rape, oil palm, sunflower, olive, corn, cottonseed, peanut, flaxseed, safflower, and coconut, with enhanced traits comprising at least one sequence of interest, further defined as conferring a preferred property selected from the group consisting of herbicide tolerance, disease resistance, insect or pest resistance, altered fatty acid, protein or carbohydrate metabolism, increased grain yield, increased oil, increased nutritional content, increased growth rates, enhanced stress tolerance, preferred maturity, enhanced organoleptic properties, altered morphological characteristics, other agronomic traits, traits for industrial uses, or traits for improved consumer appeal, wherein said traits may be nontransgenic or transgenic.

Further areas of applicability will be more particularly described below in relation to the detailed description. It should be understood that the description and specific examples are intended for purposes of illustration only and are not intended to limit the scope of the present disclosure.

### DETAILED DESCRIPTION

The definitions and methods provided define the present invention and guide those of ordinary skill in the art in the practice of the present invention. Unless otherwise noted, terms are to be understood according to conventional usage by those of ordinary skill in the relevant art. Definitions of common terms in molecular biology may also be found in Albers et al., Molecular Biology of The Cell, 5^{th} Edition, Garland Science Publishing, Inc.: New York, 2007; Rieger et al., Glossary of Genetics: Classical and Molecular, 5th edition, Springer-Verlag: New York, 1991; King et al, A Dictionary of Genetics, 6th ed, Oxford University Press: New York, 2002; and Lewin, Genes IX, Oxford University Press: New York, 2007. The nomenclature for DNA bases as set forth at 37 CFR §1.822 is used.

An “allele” refers to an alternative sequence at a particular locus; the length of an allele can be as small as 1 nucleotide base. Allelic sequence can be denoted as nucleic acid sequence or as amino acid sequence that is encoded by the nucleic acid sequence.

A “locus” is a position on a genomic sequence that is usually found by a point of reference; e.g., a short DNA sequence that is a gene, or part of a gene or intergenic region. A locus may refer to a nucleotide position at a reference point on a chromosome, such as a position from the end of the chromosome. The ordered list of loci known for a particular genome is called a genetic map. A variant of the DNA sequence at a given locus is called an allele and variation at a locus, i.e., two or more alleles, constitutes a polymorphism. The polymorphic sites of any nucleic acid sequence can be determined by comparing the nucleic acid sequences at one or more loci in two or more germplasm entries.

As used herein, “oligogenic” is phenotypic trait produced by two or more genes working together.

As used herein, a “nucleic acid sequence” comprises a contiguous region of nucleotides at a locus within the genome. Further, a nucleic acid sequence, as used herein, may comprise one or more haplotypes, portions of one or more haplotypes, one or more genes, portions of one or more genes, one or more QTL, and portions of one or more QTL. In addition, a plurality of nucleic acid sequences can comprise one or more haplotypes, portions of one or more haplotypes, one or more genes, portions of one or more genes, one or more QTL, and portions of one or more QTL. The sequence may originate from a DNA or RNA template, either directly or indirectly (i.e., cDNA obtained from reverse transcription of mRNA).

As used herein, “polymorphism” means the presence of one or more variations of a nucleic acid sequence at one or more loci in a population of one or more individuals. The variation may comprise but is not limited to one or more base changes, the insertion of one or more nucleotides or the deletion of one or more nucleotides. A polymorphism may arise from random processes in nucleic acid replication, through mutagenesis, as a result of mobile genomic elements, from copy number variation, and during the process of meiosis, such as unequal crossing over, genome duplication and chromosome breaks and fusions. The variation can be commonly found, or may exist at low frequency within a population, the former having greater utility in general plant breeding and the latter may be associated with rare but important phenotypic variation. Useful polymorphisms may include single nucleotide polymorphisms (SNPs), insertions or deletions in DNA sequence (Indels), simple sequence repeats of DNA sequence (SSRs) a restriction fragment length polymorphism, and a tag SNP. A genetic marker, a gene, a DNA-derived sequence, a haplotype, a RNA-derived sequence, a promoter, a 5′ untranslated region of a gene, a 3′ untranslated region of a gene, microRNA, siRNA, a QTL, a satellite marker, a transgene, mRNA, ds mRNA, a transcriptional profile, and a methylation pattern may comprise polymorphisms. In addition, the presence, absence, or variation in copy number of the preceding may comprise a polymorphism.

As used herein, “genotype” is the actual nucleic acid sequence at a locus in an individual plant. As opposed to a genetic marker such as a SNP, where the genotype comprises a single nucleotide, the genotype identified with the present invention is a plurality of nucleotides, where the length of the genotype is contingent on the length of the nucleic acid sequence. Notably, a genetic marker assay as known in the art (e.g., SNP detection via TaqMan) detects only two alleles. An advantage of the present invention is the ability to directly query all four nucleotides (adenine, A; thymine, T; cytosine, C; and guanine, G) simultaneously at any one nucleotide position. That is, for any one base pair position, there will be twice the information when using direct nucleic acid sequencing versus genetic marker assays. This can be very important in determining whether two lines share DNA that is identical by descent. With a SNP genotype, one can only assess whether a pair of alternative nucleic acid bases exist at a single nucleotide locus. For example, one might query whether two lines have a C or a T at a single nucleotide locus and find that one line has a C but the other has neither. However, unlike directly assessing the sequence at the single nucleotide locus, the genetic marker assay will not distinguish a failed reaction or whether an alternative base, such as an adenine or guanidine, is present at that locus. Therefore, the present invention provides greater certainty whether a given region is identical by descent by observing the nucleic acid sequence for that region.

As used herein, a nucleic acid sequence can comprise 1 or more nucleotides (for example, 2 or more nucleotides, 25 or more nucleotides, 250 or more nucleotides, 1,000 or more nucleotides, even 20,000 or more nucleotides). In certain embodiments, adjacent nucleic acid sequence fragments can be ligated in vitro or aligned in silico for the purpose of obtaining a longer nucleic acid sequence. As used herein, a nucleic acid sequence from each of two or more individual plants from the same genomic region, that may or may not be associated with one or more phenotypic trait values, provides the basis for decisions related to germplasm improvement activities, wherein one or more loci can be evaluated. Knowing whether two sequences at a locus are completely identical or if they contain combinations of identical and non-identical loci can aid in determining whether the loci have the same trait value, are linked to the same traits or are identical by descent. Therefore in another aspect, one or more nucleic acid sequences from one or more individual plants that are associated with a phenotypic trait value can provide the basis for decisions related to germplasm improvement activities.

As used herein, the term “haplotype” means a chromosomal region within a haplotype window. Typically, the unique marker fingerprint combinations in each haplotype window define and differentiate individual haplotypes for that window. As used herein, a haplotype is defined and differentiated by one or more nucleic acid sequences at one or more loci within a “haplotype window.”

As used herein, the term “haplotype window” means a chromosomal region that is established by statistical analyses known to those of skill in the art and is in linkage disequilibrium. In the art, identity by state between two inbred individuals (or two gametes) at one or more molecular marker loci located within this region is taken as evidence of identity-by-descent of the entire region, wherein each haplotype window includes at least one polymorphic molecular marker. As used herein, haplotype windows are defined by two or more nucleic acid sequence genotypes. Haplotype windows can be mapped along each chromosome in the genome and do not necessarily need to be contiguous. Haplotype windows are not fixed per se and, given the ever-increasing amount of nucleic acid sequence information, this invention anticipates the number and size of haplotype windows to evolve, with the number of windows increasing and their respective sizes decreasing, thus resulting in an ever-increasing degree confidence in ascertaining identity by descent based on the identity by state of genotypes. Haplotype windows are useful in delineating nucleic acid sequences of interest because these genomic regions tend to be inherited as linkage blocks and thus are informative for association mapping and for tracking across multiple generations.

As used herein, “phenotype” means the detectable characteristics of a cell or organism which can be influenced by genotype.

As used herein, “marker” means a detectable characteristic that can be used to discriminate between organisms. Examples of such characteristics may include genetic markers, protein composition, protein levels, oil composition, oil levels, carbohydrate composition, carbohydrate levels, fatty acid composition, fatty acid levels, amino acid composition, amino acid levels, biopolymers, pharmaceuticals, starch composition, starch levels, fermentable starch, fermentation yield, fermentation efficiency, energy yield, secondary compounds, metabolites, morphological characteristics, and agronomic characteristics. As used herein, “genetic marker” means polymorphic nucleic acid sequence or nucleic acid feature.

As used herein, “marker assay” means a method for detecting a polymorphism at a particular locus using a particular method, e.g. measurement of at least one phenotype (such as seed color, flower color, or other visually detectable trait), restriction fragment length polymorphism (RFLP), single base extension, electrophoresis, sequence alignment, allelic specific oligonucleotide hybridization (ASO), random amplified polymorphic DNA (RAPD), microarray-based technologies, and nucleic acid sequencing technologies, etc.

As used herein, “consensus sequence” means a constructed DNA sequence which identifies single nucleotide and Indel polymorphisms in alleles at a locus. Consensus sequence can be based on either strand of DNA at the locus and states the nucleotide base of either one of each SNP in the locus and the nucleotide bases of all Indels in the locus. Thus, although a consensus sequence may not be a copy of an actual DNA sequence, a consensus sequence is useful for precisely designing primers and probes for actual polymorphisms in the locus.

As used herein, “linkage” refers to relative frequency at which types of gametes are produced in a cross. For example, if locus A has genes “A” or “a” and locus B has genes “B” or “b” and a cross between parent I with AABB and parent B with aabb will produce four possible gametes where the genes are segregated into AB, Ab, aB and ab. The null expectation is that there will be independent equal segregation into each of the four possible genotypes, i.e. with no linkage ¼ of the gametes will of each genotype. Segregation of gametes into a genotypes differing from ¼ are attributed to linkage.

As used herein, “linkage disequilibrium” is defined in the context of the relative frequency of gamete types in a population of many individuals in a single generation. If the frequency of allele A is p, a is p′, B is q and b is q′, then the expected frequency (with no linkage disequilibrium) of genotype AB is pq, Ab is pq′, aB is p′q and ab is p′q′. Any deviation from the expected frequency is called linkage disequilibrium. Two loci are said to be “genetically linked” when they are in linkage disequilibrium.

As used herein, “quantitative trait locus (QTL)” means a locus that controls to some degree numerically representable traits that are usually continuously distributed.

As used herein, “DNA tag” means a short segment of DNA used as an identifier for a nucleic acid sample. A DNA tag, also known as a molecular barcode, can range from about 2 to about 20 base pairs in length and can be added during complexity reduction of the template nucleic acid sample(s). For examples, sets of DNA tags are available in U.S. Pat. No. 7,157,564. The tag can be identified via sequencing or microarray methods as described in EP 1 724 348. In other embodiments, such as in the case of oligonucleotides mass tags, mass spectrometry methods have been used to differentiate tags (Zhang et al. PNAS 2007 104:3061-3066). Further, molecular barcodes have been developed for detection by other imaging platforms, including surface plasmon resonance, fluorescent, or Raman spectroscopy, as described in U.S. Patent Application 2007/0054288. In another embodiment, spike-in tags of RNA or protein have been used which are distinct from molecules of the target sample and are co-analyzed with a plurality of samples for the purpose of sample discrimination. In a preferred embodiment of this invention, the identity of the tag is assessed by sequencing either directly before or directly after the sequencing of a trait locus. In this way, the sequence of the tag conjugated to the sequence of the locus and can be used to maintain a linkage between the locus sequence and the sample origin. In another embodiment, the tag may be combinatorial or hierarchical. For example one portion of the tag may indicate multiple nucleic acids are from the same sample and another portion of the tag may indicate the nucleic acids were derived from different sub-samples. The number of hierarchical levels or combinations of tags is only limited by the amount of sequencing which can be dedicated to the DNA tag vs. the trait locus.

As used herein, “nucleic acid sequencing” means the determination of the order of nucleotides in a sample of nucleic acids, wherein nucleic acids include DNA and RNA molecules. “High throughput nucleic acid sequencing” means an automated and massively parallel approach for the determination of nucleotides in a sample of nucleic acids wherein examples of high throughput nucleic acid sequencing technology include, but are not limited to, platforms provided by 454 Life Sciences, Agencourt Bioscience, Applied Biosystems, LI-COR Biosciences, Microchip Biotechnologies, Network Biosystems, NimbleGen Systems, Illumina, and VisiGen Biotechnologies, and Pacific Biosciences, comprising but not limited to formats such as parallel bead arrays, sequencing by synthesis, sequencing by ligation, capillary electrophoresis, electronic microchips, “biochips,” microarrays, parallel microchips, and single-molecule arrays, as reviewed by Service (Science 2006 311:1544-1546).

As used herein, “linkage assessment score” or “LAS” refers to a statistical determination of linking a SNP to a trait. For each SNP, The higher of LAS, the closer linkage to the trait. Theoretically, an unlinked marker has a LAS score of 0.25. LAS=Frequency (Recessive allele in Recessive Bulk)×[1-Frequency (Recessive allele in a Dominant Bulk)].

As used herein, “aligning” or “alignment” of two or more nucleic acid sequences is the comparison of the nucleic acid sequences found at the same locus. Several methods of alignment are known in the art and are included in most of the popular bioinformatics packages.

As used herein, the term “primer” means a single strand of synthetic oligonucleotide, preferably from about 10 to about 120 nucleotides, which can be synthesized chemically or assembled from several chemically synthesized oligonucleotides. As used herein, primers may be used to initiate sequencing reactions and polymerase reactions, such as in gap fill reactions and PCR. As used herein, a primer will hybridize under the assay conditions specifically to a desired target sequence. As used herein, primers may be used to introduce a DNA tag, to introduce chemically modified bases, such as biotin labeled bases, or to introduce a hybridization sequence that can subsequently be used for capture, such as capture to a sequencing matrix or to an avidin-containing surface.

As used herein, the term “adapters” means a double stranded nucleic acid molecule of a known composition, typically about 10 to 120 base pairs in length, which are designed such that they can be ligated, for example through the use of a DNA ligase, to one or both ends of a second nucleic acid molecule(s). Adapters can be designed to be ligated to the blunt end of a nucleic acid (blunt end adapters) or by first annealing to a specific overhang sequence and then ligated. In this embodiment, adapters may be used to provide primer sites, to tag a nucleic acid with a DNA tag, to provide sequences that enable hybridization for the purposes of capture and to add chemically modified nucleic acid sequences such as biotin containing adapters.

As used herein, the term “ligation” means the biochemical reaction catalyzed by the enzyme ligase wherein two DNA molecules are covalently joined.

As used herein, “DNA amplification” means the in vitro synthesis of double stranded DNA through the use of a DNA polymerase. Typically, this is accomplished in a polymerase chain reaction (PCR) assay but may also include other methods such as a gap-fill reaction, mis-match repair, Klenow reaction, etc. DNA amplification is used to provide detectable or excess amounts of a specific DNA. It can also be used to incorporate into a target nucleic acid, hybridized probes, annealed adaptors and primers which may include specific functionality or information.

As used herein, the term “transgene” means nucleic acid molecules in form of DNA, such as cDNA or genomic DNA, and RNA, such as mRNA or microRNA, which may be single or double stranded.

As used herein, the term “inbred” means a line that has been bred for genetic homogeneity.

As used herein, the term “hybrid” means a progeny of mating between at least two genetically dissimilar parents. Without limitation, examples of mating schemes include single crosses, modified single cross, double modified single cross, three-way cross, modified three-way cross, and double cross wherein at least one parent in a modified cross is the progeny of a cross between sister lines.

As used herein, the term “tester” means a line used in a testcross with another line wherein the tester and the lines tested are from different germplasm pools. A tester may be isogenic or nonisogenic.

As used herein, the term “corn” means Zea mays or maize and includes all plant varieties that can be bred with corn, including wild maize species. More specifically, corn plants from the species Zea mays and the subspecies Zea mays L. ssp. Mays can be genotyped using the compositions and methods of the present invention. In an additional aspect, the corn plant is from the group Zea mays L. subsp. mays Indentata, otherwise known as dent corn. In another aspect, the corn plant is from the group Zea mays L. subsp. mays Indurata, otherwise known as flint corn. In another aspect, the corn plant is from the group Zea mays L. subsp. mays Saccharata, otherwise known as sweet corn. In another aspect, the corn plant is from the group Zea mays L. subsp. mays Amylacea, otherwise known as flour corn. In a further aspect, the corn plant is from the group Zea mays L. subsp. mays Everta, otherwise known as pop corn. Zea or corn plants that can be genotyped with the compositions and methods described herein include hybrids, inbreds, partial inbreds, or members of defined or undefined populations.

As used herein, the term “soybean” means Glycine max and includes all plant varieties that can be bred with soybean, including wild soybean species. More specifically, soybean plants from the species Glycine max and the subspecies Glycine max L. ssp. max or Glycine max ssp. formosana can be genotyped using the compositions and methods of the present invention. In an additional aspect, the soybean plant is from the species Glycine soja, otherwise known as wild soybean, can be genotyped using these compositions and methods. Alternatively, soybean germplasm derived from any of Glycine max, Glycine max L. ssp. max, Glycine max ssp. Formosana, and/or Glycine soja can be genotyped using compositions and methods provided herein.

As used herein, the term “comprising” means “including but not limited to”.

As used herein, the term “elite line” means any line that has resulted from breeding and selection for superior agronomic performance. An elite plant is any plant from an elite line.

In accordance with the present invention, Applicants have discovered methods for making breeding decisions genotypically on nucleic acid sequences per se. For example, the methods of the present invention provide for direct, sequence-based analysis instead of using genetic markers as indirect tools for selecting a locus of interest. Further, the methods of the present invention allow for improved flexibility in using nucleic acid information in a breeding program, wherein the entire genome of a plant or animal can be queried without reliance on pre-determined genetic markers and the development of genetic marker detection assays. In addition, any length of sequence from any locus can be leveraged to 1) determine genotype-trait associations, 2) discriminate between two or more lines, 3) predict line performance or hybrid performance and, ultimately, 4) provide the basis for decisions in activities related to germplasm improvement.

Molecular breeding is often referred to as marker-assisted selection (MAS) and marker-assisted breeding (MAB), wherein MAS refers to making breeding decisions on the basis of molecular marker genotypes for at least one locus and MAB is a general term representing the use of molecular markers in plant breeding. In these types of molecular breeding programs, genetic marker alleles can be used to identify plants that contain the desired genotype at one marker locus, several loci, or a haplotype, and that would therefore be expected to transfer the desired genotype, along with an associated desired phenotype, to their progeny. Markers are highly useful in plant breeding because, once established, they are not subject to environmental or epistatic interactions. Furthermore, certain types of markers are suited for high throughput detection, enabling rapid identification in a cost effective manner.

Marker discovery and development in crops provides the initial framework for applications to MAB (U.S. Pat. No. 5,437,697) The resulting “genetic map” is the representation of the relative position of characterized loci (DNA markers or any other locus for which alleles can be identified) along the chromosomes. The measure of distance on this map is relative to the frequency of crossover events between sister chromatids at meiosis. As a set, polyallelic markers have served as a useful tool for fingerprinting plants to inform the degree of identity of lines or varieties (U.S. Pat. No. 6,207,367). These markers form the basis for determining associations with phenotype and can be used to drive genetic gain. The implementation of MAS, wherein selection decisions are based on marker genotypes, is dependent on the ability to detect underlying genetic differences between individuals.

Because of allelic differences in these molecular markers, QTL can be identified by statistical evaluation of the genotypes and phenotypes of segregating populations. Processes to map QTL are well-described (U.S. Pat. Nos. 5,492,547, 5,981,832, 6,455,758; reviewed in Flint-Garcia et al. 2003 Ann. Rev. Plant Biol. 54:357-374). The use of markers to infer phenotype result in the economization of a breeding program by substituting costly, time-intensive, phenotyping with genotyping. Marker approaches allow selection to occur before the plant reaches maturity, thus saving time and leading to more efficient use of plots. In fact, selection can even occur at the seed level so only preferred seeds are planted. Further, breeding programs can be designed to explicitly drive the frequency of specific, favorable phenotypes by targeting particular genotypes (U.S. Pat. No. 6,399,855). Fidelity of these associations may be monitored continuously to ensure maintained predictive ability and, thus, informed breeding decisions.

This process has evolved to the application of markers as a tool for the selection of “new and superior plants” via introgression of preferred loci as determined by statistical analyses (U.S. Pat. No. 6,219,964). Marker-assisted introgression involves the transfer of a chromosomal region, defined by one or more markers, from one germplasm to a second germplasm. The initial step in that process is the localization of the genomic region or transgene by gene mapping, which is the process of determining the position of a gene or genomic region relative to other genes and genetic markers through linkage analysis. The basic principle for linkage mapping is that the closer together two genes are on a chromosome, the more likely they are to be inherited together. Briefly, a cross is generally made between two genetically compatible but divergent parents relative to the traits of interest. Genetic markers can then be used to follow the segregation of these traits in the progeny from the cross, often a backcross (BC1), F2, or recombinant inbred population.

Historically, genetic markers were not appropriate for distinguishing identity by state or by descent. It has long been recognized that genes and genomic sequences may be identical by state (i.e., identical by independent origins; IBS) or identical by descent (i.e., through historical inheritance from a common progenitor; IBD) which has tremendous bearing on studies of linkage disequilibrium and, ultimately, mapping studies (Nordborg et al. 2002 Trends Gen. 18:83-90). Notably, newer classes of markers such as SNPs (single nucleotide polymorphisms), are more diagnostic of origin. The likelihood that a particular SNP allele is derived from independent origins in the extant populations of a particular species is very low. Polymorphisms occurring in linked genes are randomly assorted at a slow, but predictable rate, described by the decay of linkage disequilibrium or, alternatively, the approach of linkage equilibrium. Consequences of this well-established scientific discovery are that long stretches of coding DNA, defined by a specific combination of polymorphisms, are very unique and extremely improbable of existing in duplication except through linkage disequilibrium, which is indicative of recent co-ancestry from a common progenitor. The probability that a particular genomic region, as defined by some combination of alleles, indicates absolute identity of the entire intervening genetic sequence is dependent on the number of linked polymorphisms in this genomic region, barring the occurrence of recent mutations in the interval. Such loci are also referred to as haplotype windows. Each haplotype within that window is defined by specific combinations of alleles; the greater the number of alleles, the greater the number of potential haplotypes, and the greater the certainty that identity by state is a result of identity by descent at that region. The present invention permits the direct determination of IBD by using direct nucleic acid sequence information, rather than inferred by marker information.

During the development of new lines, ancestral haplotypes are maintained through the process and are typically thought of as ‘linkage blocks’ that are inherited as a unit through a pedigree. Further, if a specific haplotype has a known effect, or phenotype, it is possible to extrapolate its effect in other lines with the same haplotype. Currently, haplotypes are identified and tracked in germplasm using one or more diagnostic markers for that haplotype window. The present invention provides a method to directly identify haplotypes by using nucleic acid sequence information. Further, by using direct sequence information, more polymorphisms within any genomic region may be identified versus using only genetic markers, thus resulting in the identification of additional haplotypes. One can also better assess haplotypes that may share identity by descent. By discriminating haplotypes on a deeper level, greater fidelity in haplotype-phenotype associations can be gained. In another aspect, exotic germplasm can be queried for novel haplotypes by using direct sequence information, thus enabling the identification and subsequent leveraging of unique haplotypes.

In another approach, regions of IBD can be queried across at least one germplasm pool in order to assess genetic diversity. For example, allelic variants have been queried in order to infer genetic bottlenecks in the domestication of crop plants (reviewed in Doebley et al. 2006 Cell 127:1309-1321). However, using a marker platform to query diversity may be limiting since a single marker queries only a single position in the sequence.

Further, one theory of heterosis predicts that regions of IBD between the male and female lines used to produce a hybrid will reduce hybrid performance. Identity by descent has historically been inferred from patterns of marker alleles in different lines, wherein an identical string of markers at a series of adjacent loci may be considered identical by descent if it is unlikely to occur independently by chance. Analysis of marker fingerprints in male and female lines can identify regions of IBD. In the present invention, the genome can be directly queried for at least one locus within the genome to evaluate IBD between lines. Knowledge of these regions can inform the choice of hybrid parents, since avoiding IBD in hybrids is likely to improve performance. This knowledge may also inform breeding programs in that crosses could be designed to produce pairs of inbred lines (one male and one female) that show little or no IBD.

In one aspect of the present invention, heterosis is evaluated for at least one genomic region, wherein heterozygosity between parents in a cross as determined on an allele basis can be presumed to confer a phenotypic advantage. In another aspect of the present invention, methods are provided to evaluate heterosis in terms of genomic synteny, wherein non-colinearity for at least one locus can result in a heterotic advantage and improved performance in the hybrid.

Markers have traditionally been used to fingerprint lines and thus provide estimates of genetic purity, facilitate QA/QC operations, and assess genetic diversity. The present invention improves upon traditional marker protocols by providing methods to directly assess base pair sequences, instead of estimating underlying sequence identity from a single base position as with traditional marker protocols. For example, a typical biallelic SNP marker provides information on only one base pair position and it can only distinguish between 2, rather than 4, nucleotides.

The methods of the present invention take advantage of recent breakthroughs in high throughput sequencing to provide novel methods for molecular breeding. High throughput (HT) sequencing methodologies have recently been developed whereby information can be generated for 100 MB or more of sequence in a single sequencing machine run. It is contemplated that any commercially available HT sequencing technology, or any other commercially available nucleic acid sequencing platform that may be developed in the future, can be employed as long as the platform is capable of determining the sequence of a single nucleic acid molecule. Non-limiting examples of commercially available HT sequencing technologies are provided by 454 Life Sciences (Branford, Conn.), Agencourt Bioscience (Beverly, Mass.), Applied Biosystems (Foster City, Calif.), LI-COR Biosciences (Lincoln, Neb.), NimbleGen Systems (Madison, Wisc.), Illumina (San Diego, Calif.), and VisiGen Biotechnologies (Houston, Tex.), Pacific Biosciences (Menlo Park, Calif.) Commercially available HT sequencing technologies are also reviewed in Science (Science 2006 311:1544-1546), which is incorporated herein by reference in its entirety. In essence the Illumina Genome Analyzer, 454 Flex and the ABI Solid technology are able to determine the sequence of a single DNA molecule although that molecule may be amplified in the process. Some of these examples employ sequencing by synthesis although this is not a pre-requisite. Preferred HT sequencing platforms will generate 100 megabases, 1 gigabase or even more sequence information per run. Highly preferred HT sequencing platforms will simultaneously determine the sequence on the maximum number of individual DNA molecules. Such systems are said to be highly parallel. For this reason, the Illumina Genome Analyzer platform is generally preferred because it can sequence many more DNA molecules by generating only a small read per molecule. Platforms which generate longer reads on fewer sequences will work but may present additional challenges for time and cost efficiency.

Direct determination of the polymorphic nucleotides has key advantages over marker technologies. Although marker technologies are generally robust, they can still incorrectly report an underlying sequence, be subject to noise, and be subject to failure. Further, a marker may not span the actual genomic region of interest and, depending on the degree of linkage to the genomic region of interest, lose value in breeding populations due to recombination and loss of the linkage. Direct determination of the nucleic acid sequences overcomes the inherent limitations of a marker based system by sequencing through not just the nucleotide(s) of interest but the surrounding sequences as well. In addition, the present invention provides methods for “indirect” polymorphism detection wherein allele-specific tags are used that are immediately adjacent to the SNP so the sequencing reaction only needs to be completed as far as the tag, which is especially useful for technologies generating short reads. Indirect sequencing still overcomes the shortcomings of typical markers' tendency to be linked, vs. comprising, causal polymorphisms since the tag is essentially physically linked to the SNP. Use of nucleic acid sequencing also provides more sequence information about the loci that correlate to traits of importance, which will help breeders better understand and utilize the loci or traits. Furthermore, direct determination of nucleic acid sequences may eliminate the need for extensive up-front sequencing for marker development.

The HT sequencing technology as described in the public domain is enabling yet still inherently limited in its application to plant genotyping, even with the ability to sequence 100 megabases or even 1 gigabases of sequence per sample. The limitation arises from the need to sequence 10,000s of thousands of individuals or lines needed to support a modern breeding program. There is a need for large number of individuals or lines that are needed to identify rare recombinants between two loci of the sub-population with the highest frequency of favorable alleles at multiple loci. The ability to sequence the whole genomes of such a large number of individuals is still impractical. A means to reduce the genome to a smaller number of informative polymorphic regions is needed as well as a means to combine samples from multiple individuals into a smaller number of sequencing runs or reactions. One aspect of this invention is the use of a reproducible method to reduce the complexity of a whole genome to a representative subset of sequences which can be analyzed, compared and used for plant breeding decisions. An additional aspect of this invention is the ability to apply DNA tagging so that multiple samples can be combined in a single sequencing run. The sequences from the combined samples that are determined in parallel in a single run can then be de-convoluted and tracked back to the individual plant or plant pool which they originated.

In one aspect, the present invention provides subsets of total genomic DNA or RNA for nucleic acid sequencing such that a reduced representation sample is obtained to narrow the target for sequencing, i.e., to coding regions or regions including at least one polymorphism of interest. These subsets may sometimes be referred to as reduced complexity samples or libraries.

In another aspect of this invention, the reduced representation sample is targeted to or limited to one or more selected regions, or loci, in the genome. The selected loci can be selected based on one or more associations with one or more traits or performance characteristics or they can be a representative subset of the all loci within a genome, such as a subset evenly spaced along the chromosomes and which are segregating in the target breeding population. A preferred subset of the loci are polymorphic loci. A polymorphic locus is defined by one or more nucleotides that vary between a pair of or multiple individuals or lines. Any type of polymorphic locus may be used with this technology including but not limited to sequence length polymorphisms, repetitive sequence length polymorphisms, restriction site polymorphisms and single nucleotide polymorphisms. Single nucleotide polymorphisms are detected in a preferred embodiment of this invention. The sequence of a targeted locus can be determined by priming the locus to synthesize a complementary oligonucleotide and then directly sequencing the complementary oligonucleotide. The targeted regions can be synthesized through a gap fill reaction, primer extension reaction, a polymerase chain reaction or a combination of these reactions. Alternatively, in the case of polymorphic targeted loci, mis-match repair enzymes or ribozymes or other such nucleotide specific enzymes can be used to specifically repair a complementary oligonucleotide that is mis-matched at the polymorphic nucleotide. Once the complementary nucleotide has been extended, amplified, repaired or gap-filled, the sequence of the in vitro generated oligonucleotide can be determined and represents the sequence of the polymorphic locus. Any of these methods can be employed to directly determine the nucleotide sequence of one or both strands of one or many nucleotide regions. Since the high throughput sequencing methodologies can generate greater than 100 MB of sequence information in a single run, oligonucleotides from large number of loci can be combined and sequenced simultaneously such that the sequences of large numbers of loci can be determined in parallel in one sequencing reaction. In such an embodiment, the invention provides high-throughput and cost effective methods for the direct determination of polymorphic, or non-polymorphic, nucleotides.

In a preferred embodiment of this invention, multiple nucleic acid samples can be combined into a sample multiplex, i.e. pool, and sequenced in parallel in the same run to maximize sample throughput per sequencing run. To achieve this, a DNA tag, comprising one or more nucleotides unique for that sample, is added to the nucleic acid prepared from an individual sample. Typical DNA tags comprise 1 to 10 nucleotides but can extend to any length as long as the tag does not interfere with the ability to determine the sample sequence. For example, a DNA tag of 2 nucleotides can be use to separate a mixture of 16 samples. DNA tags of 3, 4, 5 or 6 nucleotides can be used to separate mixtures of 64, 256, 1024 or 4096 samples, and so on. Shorter DNA tags place less constraints on sequence read length but limit the number of samples which can be mixed. In one embodiment of the invention, the DNA tags are simply synthesized as part of one or both PCR primers and then incorporated in a PCR reaction. In another aspect, the DNA tag can be ligated onto the sample nucleic acids using a DNA ligase. After fully incorporating a DNA tag into the nucleic acid sample, multiple DNA preparations, each with a unique tag, can be multiplexed, i.e. pooled or combined. The multiplexed mixtures are then subjected to a single HT sequencing reaction. The number of samples that are multiplexed is based on optimally using the full sequencing capacity of a single sequencing run. Parameters that influence the complexity of a sample mixture include the number of loci being assessed, the size of the loci, the information content per run of the HT platform, the length of the DNA tag, the presence, if any, of an adapter or primer sequence and the read length of a given sequence. The level of multiplexing can be balanced to achieve optimum cost per sample, redundancy per sequence read. The minimum length of a single sequence read needs to be sufficient to read a sample DNA tag (for example, 2-5 nucleotides, depending on the number of samples which are pooled), a sequence specific tag (6-20 nucleotides) and one or more adjacent nucleotides. After the HT sequencing reaction, sequences with the same DNA tag are first separated logically into separate pools which represent the individual or line or pool which the DNA was extracted. The sequences with identical DNA tags can then be read to determine the nucleotide identity within the loci which were selected to be queried.

In this invention, the sequence of nucleic acids can be associated to traits of interest or to plant performance and then used to make selections of parents, progeny or testers. Sequences will be useful if they are genetically linked to the trait or performance characteristic. Typically, they are genetically linked if they are causative for the trait or performance characteristic or are closely physically linked to the trait or performance loci. In the case of physically linked sequences, no knowledge of the gene(s) and/or causative variation for the trait or performance information is required. One only needs to determine the sequence of the physically linked nucleotides. Once a sequence has been genetically linked to a trait or performance character, the sequence of the nucleic acids can be directly used to select parents, progeny or testers which will exemplify that trait or performance without the need to first measure the trait or performance characteristic. The knowledge of the nucleotide sequences can also be used to fingerprint a plant or line and be used to measure genetic similarity/distance among plants or lines and to build pedigrees. The pedigrees can then be used to make selections of parents or to manage the diversity in a germplasm pool.

As provided by the present invention, the knowledge of nucleic acid sequences can be applied to make decisions at multiple stages of the breeding program:

a) Among segregating progeny, as a pre-selection method, to increase the selection index and drive the frequency of favorable nucleic acid sequences among breeding populations, wherein pre-selection is defined as selection among offspring of a breeding cross based on the genotype of these progenies at a selected set of two or more nucleic acid sequences at one or more loci as determined by HT sequencing, and leveraging of nucleic acid sequence-trait associations identified in previous breeding crosses.

b) Among segregating progeny from a breeding population, to increase the frequency of the favorable nucleic acid sequences for the purpose of line or variety development.

c) Among segregating progeny from a breeding population, to increase the frequency of the favorable nucleic acid sequences prior to QTL mapping within this breeding population.

d) For hybrid crops, among parental lines from different heterotic groups to predict the performance potential of different hybrids.

In another embodiment, the present invention provides a method for improving plant germplasm by accumulation of nucleic acid sequences of interest in a germplasm comprising determining nucleic acid sequences for at least two loci in the genome of a species of plant, and associating the nucleic acid sequences with at least one trait, and using this nucleic acid sequence effect estimates to direct breeding decisions. These nucleic acid sequence effect estimates can be derived using historical nucleic acid sequence-trait associations or de novo from mapping populations. The nucleic acid sequence effect estimates for one or more traits provide the basis for making decisions in a breeding program. This invention also provides an alternative basis for decision-making using breeding value calculations based on the estimated effect and frequency of nucleic acid sequences in the germplasm. Nucleic acid sequence breeding values can be used to rank a specified set of nucleic acid sequences. In the context of the specified set of nucleic acid sequences, these breeding values form the basis for calculating an index to rank the alleles both within and between loci.

Further, methods for determining the statistical significance of a correlation between a phenotype and a genotype, in this case a nucleic acid sequence, may be determined by any statistical test known in the art and with any accepted threshold of statistical significance being required. The application of particular methods and thresholds of significance are well with in the skill of the ordinary practitioner of the art.

Nucleic acid sequence effect estimates and/or breeding values for one or more traits of interest provide the basis for determining one or more nucleic acid sequences of interest in comparisons of two or more nucleic acid sequences. With this a priori information, breeding selections are conducted on a nucleic acid sequence, rather than marker, basis, wherein a first plant is crossed with a second plant that contains at least one locus where the nucleic acid sequence of the second plant is different from the first plant nucleic acid sequence; and at least one progeny plant is selected by detecting the nucleic acid sequence or set of nucleic acid sequences of the first plant, wherein the progeny plant comprises in its genome one or more nucleic acid sequences of interest of the first plant and at least one nucleic acid sequence of interest of the second plant; and the progeny plant is used in activities related to germplasm improvement, herein defined as including using the plant for line and variety development, hybrid development, transgenic event selection, making breeding crosses, testing and advancing a plant through self fertilization, purification of lines or sublines, using plant or parts thereof for transformation, using plants or parts thereof for candidates for expression constructs, and using plant or parts thereof for mutagenesis.

In one aspect, this invention provides high throughput sequencing to identify large segments of nucleic acids, in one or more regions of a plant genome, that provide a basis to compare two or more germplasm entries. These regions of contiguous nucleic acid sequence are indicative of the conservation of genetic identity of all intervening genes from a common progenitor. In cases where conserved sequence segments are coincident with segments in which QTL have been identified it is possible to deduce with high probability that QTL inferences can be extrapolated to other germplasm having an identical sequence in that locus. This a priori information provides the basis to select for favorable QTLs prior to QTL mapping within a given population.

For example, plant breeding decisions could comprise:
a) Selection among new breeding populations to determine which populations have the highest frequency of favorable nucleic acid sequences, wherein sequences are designated as favorable based on coincidence with previous QTL mapping; or
b) Selection of progeny containing said favorable nucleic acid sequences in breeding populations prior to, or in substitution for, QTL mapping within that population, wherein selection could be done at any stage of breeding and could also be used to drive multiple generations of recurrent selection; or
c) Prediction of progeny performance for specific breeding crosses; or
d) Selection of lines for germplasm improvement activities based on said favorable haplotypes, including line development, hybrid development, selection among transgenic events based on the breeding value of the haplotype that the transgene was inserted into, making breeding crosses, testing and advancing a plant through self fertilization, using plant or parts thereof for transformation, using plants or parts thereof for candidates for expression constructs, and using plant or parts thereof for mutagenesis.

An additional unique aspect of this invention is the ability to select for specific genes or gene alleles, as they are targeted by high throughput sequencing. For example, in cases where the nucleic acid sequence is coincident with segments in which genes have been identified it is possible to deduce with high probability that gene inferences can be extrapolated to other germplasm having an identical genotype in that locus. This a priori information provides the basis to select for favorable genes or gene alleles on the basis of nucleic acid sequencing within a given population.

For example, plant breeding decisions could comprise:
a) Selection among new breeding populations to determine which populations have the highest frequency of favorable nucleic acid sequences, wherein sequences are designated as favorable based on coincidence with previous gene mapping; or
b) Selection of progeny containing said favorable nucleic acid sequences in breeding populations, wherein selection is effectively enabled at the gene level, wherein selection could be done at any stage of inbreeding and could also be used to drive multiple generations of recurrent selection; or
c) Prediction of progeny performance for specific breeding crosses; or
d) Selection of lines for germplasm improvement activities based on said favorable haplotypes, including line development, hybrid development, selection among transgenic events based on the breeding value of the haplotype that the transgene was inserted into, making breeding crosses, testing and advancing a plant through self fertilization, using plant or parts thereof for transformation, using plants or parts thereof for candidates for expression constructs, and using plant or parts thereof for mutagenesis.

Further, in another preferred embodiment of this invention, the a priori information on the frequency of favorable nucleic acid sequences in breeding populations enables pre-selection. That is, parental lines are selected based on the historical genotype-phenotype association information for the purpose of driving favorable nucleic acid frequency for multiple traits simultaneously. In pre-selection, breeders can predict the phenotypic contribution for multiple traits of any line based on that line's fingerprint information, which corresponds to a composition of pre-defined sequences. This multi-trait sequence selection approach economizes a breeding program by initiating selection at the initial stage of choosing parental crosses and it also reduces the need for costly, time-consuming phenotyping of progeny.

A preferred sequence provides a preferred property to a parent plant and to the progeny of the parent when selected by a marker means or phenotypic means. The method of the present invention provides for selection of preferred sequences, or sequences of interest, and the accumulation of these sequences in a breeding population.

Another preferred embodiment of the present invention is to build additional value by selecting a composition of nucleic acid sequences wherein each sequence has an estimated associated phenotype that is not negative with respect to yield, or is not positive with respect to maturity, or is null with respect to maturity, or amongst the best 50 percent with respect an agronomic trait, transgene, and/or a multiple trait index when compared to any other nucleic acid sequence at the same locus in a set of germplasm, or amongst the best 50 percent with respect to an agronomic trait, transgene, and/or a multiple trait index when compared to any other loci across the entire genome in a set of germplasm, or the nucleic acid sequence being present with a frequency of 75 percent or more in a breeding population or a set of germplasm can be taken as evidence of its high value, or any combination of these.

This invention anticipates a stacking of nucleic acid sequences from at least two loci into plants or lines by crossing parent plants or lines containing different nucleic acid sequences, that is, different genotypes. The value of the plant or line comprising in its genome stacked nucleic acid sequences from two or more loci can be estimated by a composite breeding value, which depends on a combination of the value of the traits and the value of the nucleic acid sequence(s) to which the traits are linked. The present invention further anticipates that the composite breeding value of a plant or line can be improved by modifying the components of one or each of the nucleic acid sequences. Additionally, the present invention anticipates that additional value can be built into the composite breeding value of a plant or line by selection of at least one recipient nucleic acid sequence with a preferred nucleic acid sequence effect estimate or, in conjunction with the frequency of said nucleic acid sequence in the germplasm pool, breeding value to which one or any of the other nucleic acid sequences are linked, or by selection of plants or lines for stacking two or more nucleic acid sequences from two or more loci by breeding.

Another embodiment of this invention is a method for enhancing breeding populations by accumulation of one or more nucleic acid sequences in one or more loci, in a germplasm. Loci include genetic information and provide phenotypic traits to the plant. Variations in the genetic information can result in variation of the phenotypic trait and the value of the phenotype can be measured. The genetic mapping of the nucleic acid sequences allows for a determination of linkage across sequences. The nucleic acid sequence of interest is novel in the genome of the progeny plant and can in itself serve as a genetic marker of a locus of interest. Notably, this nucleic acid sequence can also be used as an identifier for a gene or QTL. For example, in the event of multiple traits or trait effects associated with the nucleic acid sequence, only one marker would be necessary for selection purposes. Additionally, the locus of interest may provide a means to select for plants that have the linked locus.

In another embodiment, at least one preferred nucleic acid of the present invention is stacked with at least one transgene. In another aspect, at least one transgenic event is advanced based on linkage with or insertion in a preferred nucleic acid, as disclosed in published U.S. Patent Application US 2006/0282911, which is incorporated herein by reference in its entirety.

In still another embodiment, the present invention acknowledges that preferred nucleic acids identified by the methods presented herein may be advanced as candidate genes for inclusion in expression constructs, i.e., transgenes. Nucleic acids of interest may be expressed in plant cells by operably linking them to a promoter functional in plants. In another aspect, nucleic acids of interest may have their expression modified by double-stranded RNA-mediated gene suppression, also known as RNA interference s(“RNAi”), which includes suppression mediated by small interfering RNAs (“siRNA”), trans-acting small interfering RNAs (“ta-siRNA”), or microRNAs (“miRNA”). Examples of RNAi methodology suitable for use in plants are described in detail in U.S. patent application publications 2006/0200878 and 2007/0011775.

Methods are known in the art for assembling and introducing constructs into a cell in such a manner that the nucleic acid molecule for a trait is transcribed into a functional mRNA molecule that is translated and expressed as a protein product. For the practice of the present invention, conventional compositions and methods for preparing and using constructs and host cells are well known to one skilled in the art, see for example, Molecular Cloning: A Laboratory Manual, 3rd edition Volumes 1, 2, and 3 (2000) J. F. Sambrook, D. W. Russell, and N. Irwin, Cold Spring Harbor Laboratory Press. Methods for making transformation constructs particularly suited to plant transformation include, without limitation, those described in U.S. Pat. Nos. 4,971,908, 4,940,835, 4,769,061 and 4,757,011, all of which are herein incorporated by reference in their entirety. Transformation methods for the introduction of expression units into plants are known in the art and include electroporation as illustrated in U.S. Pat. No. 5,384,253; microprojectile bombardment as illustrated in U.S. Pat. Nos. 5,015,580; 5,550,318; 5,538,880; 6,160,208; 6,399,861; and 6,403,865; protoplast transformation as illustrated in U.S. Pat. No. 5,508,184; and Agrobacterium-mediated transformation as illustrated in U.S. Pat. Nos. 5,635,055; 5,824,877; 5,591,616; 5,981,840; and 6,384,301.

The present invention also provides for the screening of progeny plants′ loci of interest as the basis for selection for use in a breeding program to enhance the accumulation of preferred nucleic acid sequences.

Using this method, the present invention contemplates that nucleic acid sequences of interest are selected from a large population of plants. Additionally, these nucleic acid sequences can be used in the described breeding methods to accumulate other beneficial and preferred loci and maintain these in a breeding population to enhance the overall germplasm of the plant. Plants considered for use in the method include but are not limited to, corn, soybean, cotton, wheat, rice, canola, oilseed rape, sugar beet, sorghum, millet, alfalfa, forage crops, oilseed crops, grain crops, fruit crops, ornamental plants, vegetable crops, fiber crops, spice crops, nut crops, turf crops, sugar crops, beverage crops, tuber crops, root crops, and forest crops.

In summary, this invention describes the novel combination of high throughput sequencing and molecular breeding methodologies to enable the use of direct nucleic acid sequence information to carry out molecular plant breeding.

The invention also includes means to selectively target polymorphic nucleotide sites and to DNA tag samples prior to sequence determination. Taken together, this invention enables the plant breeder to use sequence information in parent selection, progeny selection, choosing tester combinations, developing pedigrees, fingerprinting samples, screening for haplotype diversity, and sequence associations to trait and performance data. (Look at disclosure)

### EXAMPLES

### Example 1

### Trait Mapping by Chip-Based Reduction

An important aim of any breeding program is to incorporate economically or otherwise important traits into a breeding line or population. The ability to directly determine the sequence of region linked to the trait or to directly determine the sequence(s) of the loci which are causative to the trait will allow the breeder to determine which individuals or lines in a population likely exhibit the trait of interest and thus inform advancement decisions.

This invention allows rapid determination of the location of the genome responsible for the phenotype of interest, as well as identifying SNPs diagnostic for the phenotype under study. To begin, a cross is made between two plants that differ for a phenotype of interest. This produces either a uniform F1 population if the plants were inbred or a genetic and phenotypically variable population if the plants were not inbred. In either condition, the F1 plants are selfed to produce a segregating F2 population. In both cases the trait of interest will now be segregating. The F2 plants are then selfed, resulting in F3 families. The F3 families will either be uniform for the presence of the trait, the absence of the trait or still segregating for the trait. When all F3 populations are uniform for the trait, the F2 individual they were derived from is diagnosed as genetically homozygous for the genomic region(s) controlling the trait. This group of uniform families is further divided if they positive or negative for the trait of interest. F2s that result in F3 families that segregate are diagnosed as genetically homozygous. This is the basic outline for a monogenic trait. This can be easily expanded encompass traits under control of numerous loci.

At this point, the user has in hand three sets of F3 families. One set is homozygous positive for the trait of interest, the second is homozygous negative for the trait of interest and the third is heterozygous for the trait of interest. DNA is then extracted from each F3 family homozygous negative and homozygous positive. DNA is then pooled in equimolar amounts from each homozygous negative F3 family and each homozygous positive F3 family. The user now has in hand two pools of DNA; one exclusively from homozygous negative plants and one from homozygous positive plants. These pools contain the sum of the recombination events of two meiotic events by the number of individuals sampled.

At this point, the user then employs sequence capture technology to construct a capture tiling path that evenly covers the genome of the target plant given the biological restrictions of genome size and repetitive DNA distribution. The homozygous negative pool is then hybridized and the target tiling path for enriched. The homozygous positive pool is then hybridized and the tiling path enriched.

The user now has in hand two genomic libraries, both enriched for a certain fraction of the genome that is evenly spaced across each chromosome. These two libraries are then sequenced to a level of coverage suitable for the particular experiment. In general, this will be deep enough to diagnose SNPs accurately within each library.

The resulting sequencing reads are then mapped back to the genome and SNPs are called within both the positive and negative libraries. The frequency of these SNPs is calculated within each library. Next SNPs are called between the two libraries. In the ideal scenario, one part of the genome stands out as having a set of SNPs that are fixed between the two libraries while SNPs within the libraries are heterozygous. This is diagnostic of a region of the genome that is responsible for the phenotype of interest.

To make the process more robust, the SNPs are binned in a sliding window and the instantaneous allele frequency is calculated within each library. A statistical model is then used to diagnose when the allele frequency is decaying to zero within both libraries as the user approaches the trait of interest, and climbs from zero as the user moves away. This is recombinational evidence for the presence of a genetic element controlling the phenotypic trait. This process constitutes mapping the phenotypic trait to the location of the genome responsible for genetic control.

The user now has in hand genomic locations statistically linked to the phenotype. Next, SNPs diagnostic for the positive or negative phenotype can be found by examining the sequence data between the two pools. These SNPs will be in linkage with the trait of interest.

### Example 2

### Determining the Suitability for Trait Mapping

Traits of value with a simple genetic basis are considered as promising candidates. This methodology can be extended to traits of more complex inheritance, particularly when those crops have existing marker platforms that can be used to increase the robustness of selection.

The number of SNPs needed to perform the method depends upon several factors, including: (1) the size of the plant genome, (2) the desired proximity of the SNP to the gene of interest, (3) the accepted likelihood of achieving the desired proximity, (4) the number of SNPs within a window flanking the gene of interest. The end user decides how close a SNP must be to serve a purpose in mapping or marker assisted breeding. With this information in mind, we currently use a theoretical prediction is used to determine a rough target number of SNPs to interrogate. A good general target is 1,000 SNPs (I. J. Mackay and P. D. S. Caligari Crop Science 40:626-630 (2000).

The bulk size has an important influence on the success of the method to reveal linked SNPs. A bulk size greater than five is necessary to reduce the number of false positive SNPs attained, where a false positive SNP is one that appears to be linked to the gene of interest, but in fact is unlinked. In addition, we show that larger bulks lead to more efficient sequencing. The reason is that when sampling from a population, the first sample will always reveal a novel haplotype. The second sample will reveal a novel haplotype at a frequency of 1-(½N), where 2N is the number of haplotypes in the bulk. Once half of the haplotypes have been sampled, the probability that a sample will reveal a novel haplotype is 0.5, and subsequently each new sample reveals a new haplotype with a decreasing probability. Thus, sequencing becomes less efficient when more than half of the haplotypes have been identified, where efficiency is defined as the likelihood of obtaining useful information from each new sequence (i.e. sample). In particular, when trying to identify the final haplotype in a bulk, each new sequence yields only a paltry probability of success (½N). Consequently, we can make our BSA projects more efficient by maximizing the number of haplotypes identified per sequence by targeting bulk sizes that are twice as large as theoretical minimum¹ that reduces false-positives, or according to the desires of the end users. It is recommended that bulk sizes in excess of 20 individuals such that 10 individuals, or 20 haplotypes, can be successfully queried without crossing into the diminishing returns threshold.

Once a number of SNPs is chosen to yield a successful experiment, we have to determine how much sequencing to do in order to accurately identify these SNPs when they occur given the size of the phenotypic bulks. For this method, DNA from several lines or families is combined for pooled sequencing. These bulks have N individuals and 2N possible unique haplotypes. The more haplotypes are identified, the more confident we can be that a SNP is or is not linked to a gene of interest. However, it is not sufficient to produce 2N sequences to identify all possible haplotypes. The reason for this derives from the fact that in any sampling approach, there is a certain probability that not all events (i.e. haplotypes) will be sampled. Because this method uses a pooled sampling approach, we cannot determine the proportion of haplotypes that have been represented, unless we observe 2N unique haplotypes, or unless we know a priori how many haplotypes are included in the bulk. Thus, the more sequences produced, the greater the probability that we can identify all haplotypes from a bulk.

Plant genomes are too large to sequence the entire genome from all individuals in a bulk at a depth sufficient for this method. Consequently, we sequence a fraction of the genome creating a reduced representation library. A plant genome is digested with a restriction enzyme, and the digested genome is treated with shrimp alkaline phosphatase to prevent fragment conjunction. Genomic fragments migrate within a 1.2% low melt gel with a ladder, and fragments from a specific size range are physically cut from the gel. These fragments are isolated by melting and digesting the gel. We then attach double stranded oligos that complement the sticky ends of the digested genomic fragments. Primers designed to anneal to these adapter-oligos are then used in several rounds of PCR. These double stranded DNAs produced and sequenced using massive parallel sequencing technologies including 454 pyrosequencing and Solexa sequencing.

The sequences generated are used to construct a pseudo molecule using the program Newbler. Once this reference molecule is produced, the individual reads are mapped onto the reference using Mosaik. SNPs are identified based on those reads that successfully map to the reference. The frequency of each allele and the sequencing depth of each allele at a putative SNP is reported to the end user.

The end user by looks for SNPs with alleles that are (a) polymorphic across bulks and (b) monomorphic within bulks. The end user can easily conduct this method by constructing a worksheet with SNP ID, major allele frequency in bulk 1, minor allele frequency in bulk 2, and total coverage as columns. The user can then sort on (a) allele frequency and (b) coverage to identify SNPs with alleles that deviate significantly from the expected frequency of 0.5 for unlinked alleles.

Once SNPs putatively linked to a gene of interest are identified, they must be validated to ensure that they are not false positives. This validation entails developing a marker based on that SNP and using that marker to genotype individuals that can reveal whether the interrogated SNP is close to the target gene. For example, as we describe below, we interrogate SNPs using the individuals used to generate the bulks and in a larger mapping population. Based on these results, the physical proximity of a SNP to a gene of interest can be quantified.

### Example 3

### No Gel or All Flesh Tomato

An experiment was conducted in tomato. The trait is referred to as “No Gel” or “All Flesh”. Wild type processing tomatoes have a gel matrix surrounding the seeds within the locules. A mutant allele was identified that reduces the amount of gel, where the wild type allele is dominant. A mapping population was generated by crossing a No Gel line with a wild type line. Full sib F3 families were planted in the field in Chile and the phenotype of each individual was determined. 10 F3 families exhibiting an absence of segregation for the No Gel and Gel phenotype were identified. Several grams of leaf tissue were collected from these 20 F3 families, freeze dried in the field, and shipped to Woodland. DNA was extracted from each line and quantified.

In all three experiments, reduced representation genomic DNA isolated from PstI-cuts, for which the whole-genome coverage has been assessed using Monsanto genetic maps and SNP markers. In the tomato trait mapping experiment, all 12 chromosomes were covered by 454 contigs with the averaged genetic gapsize of 1.5 cM.

Reduced representation libraries were made from the two parents of this mapping population and 454 sequencing was performed. The purpose of this sequencing was to identify which gel fractions should be targeted for sequencing of pooled DNA. The 0.5 to 1.5 kb fraction yielded 8,627 distinct fragments, 657 of which had a total of 1,027 SNPs.

Based on the parent sequencing information, we targeted the 0.5 to 1.5 kb fraction for subsequent sequencing. Two micrograms of DNA were combined from each of five phenotypically similar F3 families to construct two Gel pools (n=5 each) and two No Gel pools (n=5 each) for use as described above. In addition, 10 micrograms from each of the 20 F3 families was prepared individually following the protocol as described above. The purpose for sequencing the individual families was to enable us to re-create the four Gel/No Gel pools in silico to determine if results from pre-library construction pooling were identical to results from post-library construction pooling.

Based on an assembly 128 candidate SNPs were identified where an allele at the SNP was >0.9 in one pool, and the same allele was <0.1 in the opposite bulk (see Figure: Histogram of First Assembly Results). In this histogram, coverage, or the amount of sequencing depth is indicated on the X axis. For example, for an A/T SNP, if the frequency of the A allele was >0.9 in the gel bulk, and <0.1 in the no gel pool, then we would consider this A/T SNP as a candidate for subsequent validation. To further reduce the number of SNPs to validate, we chose those SNPs that had >10 sequences represented. Ten was chosen as a cutoff based on simulation results showing that in 50 samples of 100 sequences, a sub-sample of 10 will reveal at least six unique sequences. This cutoff of six unique sequences was chosen based on the logic described in earlier sections.

Because many SNPs were present within the same contig, we identified those contigs which were unique, and conducted a BLAST search to identify fully sequenced BACs which exhibit significant DNA sequence similarity to these contigs. Using the default parameters, many BACs were identified that harbor sequence which is similar to contigs revealed through prior methods. This analysis suggests that the invention identified a number of contigs that are likely to reside on chromosome 6 of tomato have shown that the No Gel gene resides on chromosome 6. Note that other chromosomes were identified as well in this analysis. This does not necessarily indicate false positives, but could derive from incomplete sequencing of the tomato genome at present. Based on these results, coverage, and allele frequency data, eleven contigs were chosen for the design of Taqman assays to interrogate a single SNP identified through trait mapping experiments.

Eleven Taqman assays were tested on the parents of the mapping population and 19 of the 20 F2:3 families used to create the phenotypic pools. These were repeated for a total two replicates per marker by line combination. One of these assays performed poorly and will not be discussed further. The remaining 10 assays are designated by a marker root name beginning with NL. Note that one F2:3 line in the Gel pool, and one F2:3 line in the No Gel pool, have genotypes revealed by the ten Taqman assays that appear to belong to the opposite pool.

The resulted score, named as linkage assessment score (LAS) can be ranked to rapidly identify SNPs potentially linked to the trait of interest: the SNP site with the higher score should have the closer linkage. The histogram of all scores can be used as a diagnostic plot to quickly assess the success of the whole experiment

Experiments wanted to determine the approximate location of the Taqman markers and the No Gel gene. The marker Aps-1 is 18-20 cM from the No Gel gene. Aps-1, in turn, is 0.89 recombination units from the Mi root knot nematode resistance gene (Williamson and Cowell, 1991). A BAC containing Mi root knot nematode resistance (C06HBA0250I21 aka LE_HBa025OI21) has been physically mapped to approximately 5 cM. Thus, the No Gel gene at approximately 18-20 cM south of the Aps-1 marker (˜4-6 cM), at ˜22-26 cM. The SNP NL5113524 mapped to the same BAC as that harboring Mi resistance (C06HBA025OI21, indicating that this SNP likely maps to ˜5 cM. There is a SNP on the consensus tomato map at position 5.3 cM (G-NL0234309). This SNP was interrogated using an Illumina assay on 96 F2 individuals from a No Gel mapping population. All ten Taqman markers that correspond to SNPs identified through trait mapping experiments were also tested on this mapping population of 96 F2 plants. Based on this work, the following SNPs all appear to be closer to G-NL0234309 than the nearest recombination event in this mapping population of 96 plants (NL5113496, NL5113500, NL5113492, NL5113518, NL5113524, and NL5113488). Interestingly, NL5113524 maps to a BAC at ˜5 cM (C06HBA0250I21), and in our F2:3 group of 19 plants, NL5113524 appears to be approximately 16 cM from the No Gel gene, as there are 6 recombination events (out of 38 possible) separating NL5113524 and the No Gel gene. This is similar in map distance to that revealed by the independent study from Peotec scientists, showing the No Gel gene is ˜18-20 cM from Aps-1. The remaining four SNPs, NL5113489, NL5113496, NL5113500 and NL5113515 appear to be closer to the No Gel gene than the nearest recombination event present in the group of 19 F2 individuals used in trait mapping experiments. Of these four markers, NL5113496 and NL5113500 appear to be closer to G-NL0234309 than the nearest recombination event in the mapping population of 96 individuals. In contrast, both NL5113489 and NL5113515 appear to be one recombination event from G-NL0234309. Thus, we place NL5113489 and NL5113515 closer to the No Gel gene, and NL5113496 and NL5113500 closer to G-NL023409

In summary, the experiment revealed a large number of contigs that mapped to BACs placed on chromosome 6. Taqman assays were designed to interrogate SNPs residing in eleven of these contigs. Of the ten Taqman assays that worked, all map to chromosome 6 because in an F2 mapping population of 96 plants, they are 0 or 1 recombination events from a marker on our consensus map that resides at 5.3 cM on chromosome 6. Because we are working on the top of chromosome 6, we can infer that many if not all of these SNPs map in the vicinity of the region delimited by Aps-1 (˜5 cM) and the No Gel gene (˜22-26 cM), with some error around these estimates based on limited mapping populations. This invention has provided a number of candidate SNPs for mapping and marker-assisted breeding that appear to be close to the targeted locus.

These experiments have been proved successful, demonstrating its efficacy and efficiency for rapid genetic mapping of traits and developing novel SNP markers. These experiments also demonstrated that, for the species without any genetic marker or limited genetic and genomic resources, by sequencing the reduced representation genomic DNAs from two phenotypic pools can help develop novel markers not only linked to the traits of interests but also for whole genome genetic map construction. The genome-wide polymorphic regions between the pooled haplotypes of both pools can also be identified as introgression events. The whole-genome coverage by our reduced representation genomic DNAs (PstI-digested fragments) has been proved successful in tomato. The optimized bioinformatics methods enable the development of high-quality tightly linked SNP markers in a rapid fashion.

We claim:

1. A method of identifying polymorphisms in a population of plants, the method comprising:
providing a population of plants;
screening the population of plants for at least one phenotype of interest;
separating plants from the population into at least two subpopulations of plants that are segregating for the at least one phenotype of interest.
isolating and pooling DNA from one or more plants in each of the subpopulations of plants;
determining the sequence of a plurality of nucleic acids for the genome of each pool from each of the subpopulations of plants; and
identifying one or more polymorphisms in the genome of each pool linked to one or more genes controlling said selected phenotype of interest.

2. The method of claim 1, wherein the population of plants comprise a crop plant selected from the group consisting of a forage crop, oilseed crop, grain crop, fruit crop, ornamental plants, vegetable crop, fiber crop, spice crop, nut crop, turf crop, sugar crop, beverage crop, tuber crop, root crop, and forest crop.

3. The method of claim 1, wherein the at least one phenotype of interest is determined by a monogenic trait.

4. The method of claim 1, wherein the at least one phenotype of interest is determined by a polygenic trait.

5. The method of claim 1, wherein the at least one phenotype of interest is determined by an oligogenic trait.

6. The method of claim 1, wherein the at least one phenotype of interest is selected from the group consisting of herbicide tolerance, disease resistance, insect or pest resistance, altered fatty acid, protein or carbohydrate metabolism, increased grain yield, increased oil, enhanced nutritional content, increased growth rates, enhanced stress tolerance, preferred maturity, enhanced organoleptic properties, altered morphological characteristics, sterility, other agronomic traits, industrial uses, or traits for improved consumer appeal.

7. The method of claim 1, wherein the method of identifying polymorphisms in a plant comprises advancing lines in germplasm improvement activities.

8. The method of claim 7, wherein the germplasm improvement activities are selected from the group consisting of line and variety development, hybrid development, transgenic event selection, making breeding crosses, testing and advancing a plant through self fertilization, purification of lines or sublines, using plant or parts thereof for transformation, using plants or parts thereof for candidates for expression constructs, and using plant or parts thereof for mutagenesis.

9. A method of identifying polymorphisms in a population of plants, the method comprising:
screening a population of plants for at least one phenotypic trait;
selecting at least one plant from the population of plants, the at least one plant having screened as positive for the at least one phenotypic trait;
isolating and collecting DNA from at least one plant screening as positive for the at least one phenotypic trait to create a positive DNA pool;
selecting at least one plant from the population of plants, the at least one plant having screened as negative for the at least one phenotypic trait;
isolating and collecting DNA from at least one plant screening as negative for the at least one phenotypic trait to create a negative DNA pool;
determining the sequence of a plurality of nucleic acids for the genome of each of said positive DNA pool and said negative DNA pool; and identifying one or more polymorphisms in said positive DNA pool or said negative DNA pool linked to one or more genes controlling the at least one phenotypic trait.

10. The method of claim 9, wherein the population of plants comprise a crop plant selected from the group consisting of a forage crop, oilseed crop, grain crop, fruit crop, ornamental plants, vegetable crop, fiber crop, spice crop, nut crop, turf crop, sugar crop, beverage crop, tuber crop, root crop, and forest crop.

11. The method of claim 9, wherein the at least one phenotype of interest is selected from the group consisting of herbicide tolerance, disease resistance, insect or pest resistance, altered fatty acid, protein or carbohydrate metabolism, increased grain yield, increased oil, enhanced nutritional content, increased growth rates, enhanced stress tolerance, preferred maturity, enhanced organoleptic properties, altered morphological characteristics, sterility, other agronomic traits, traits for industrial uses, or traits for improved consumer appeal.

12. The method of claim 9, wherein the method of identifying polymorphisms in a plant comprises advancing lines in germplasm improvement activities.

13. The method of claim 12, wherein the germplasm improvement activities are selected from the group consisting of line and variety development, hybrid development, transgenic event selection, making breeding crosses, testing and advancing a plant through self fertilization, purification of lines or sublines, using plant or parts thereof for transformation, using plants or parts thereof for candidates for expression constructs, and using plant or parts thereof for mutagenesis.
